(19) United States
(12) Patent Application Publication
(10) Pub. No.: US 2023/0263199 A1
(43) Pub. Date: Aug. 24, 2023

(54) EASY-TO-COOK AND EASY-TO-BREW NOODLES OF PHYSICAL FABRICATION PROCESS

(71) Applicant: A-SHA REPUBLIC INC., TAIPEI CITY (TW)

(72) Inventor: TA-WEI LO, TAIPEI CITY (TW)

(21) Appl. No.: 18/138,127

(22) Filed: Apr. 24, 2023

Related U.S. Application Data
(63) Continuation-in-part of application No. 17/330,424, filed on May 26, 2021.

(51) Int. Cl. A23L 7/113; A23P 30/20; A23L 5/10; A23L 3/40

(52) U.S. Cl. CPC A23L 7/113; A23P 30/20; A23L 5/13; A23L 3/40

(57) ABSTRACT

Easy-to-cook and easy-to-brew noodles of physical fabrication process are provided, in which an appropriate amount of strong/medium strength flour or semolina or durum wheat flour is taken as a noodle base material, which is mixed with water and salt to forming a mixture that is extruded to form noodles of various shapes of thin strips spiral, or sheet. The so formed noodle are then steamed and cut quantitatively and the subjected to semi-puff drying or full-puff drying according to the thickness or set brewing time of the noodles so as to make instant pasta through the physical fabrication process, allowing the pasta to be brewed or cooked in a short time, and fast edible. The physical fabrication process does not involve adding of oil or additives, such as leavening agent or starch, and thus does not affect human health.

### CROSS-REFERENCE TO RELATED APPLICATIONS

This is a continuation-in-part of co-pending U.S. patent application Ser. No. 17/330,424 filed on May 26, 2021.

### TECHNICAL FIELD OF THE INVENTION

The present invention relates to easy-to-cook and easy-to-brew noodles of a physical fabrication process, and more particularly to easy-to-cook and easy-to-brew noodles, making pasta ready for brewing or short-time cooking, and fast edible.

### DESCRIPTION OF THE PRIOR ART

Pasta generally refers to all kinds of noodles from Italy. In Italy, “pasta” is generally used to refer to various noodles made of flour, water, and sometimes eggs. In a narrow sense, pasta is made of durum wheat flour or semolina, and in a broad sense, it can include other grains as raw materials. The characteristic of pasta is that there are many different types, such as long and moderately thick spaghetti, thicker and flat Italian linguine, thinner angel hair, twisted fusilli, and many other kinds. In addition to Italy and Europe, pasta also has a high degree of popularity all over the world, and is favored by consumers. However, pasta must be cooked in water for a longer time (usually 8 to 13 minutes) because it is not easy to absorb water, and the cooked pasta tastes hard.

Instant noodles that are popular in the Asia countries and regions are noodles that can be cooked or brewed in a short period of time. The principle of instant noodles is to harden cooked and seasoned noodles and press them into blocks, and the noodle blocks are brewed or simply cooked in hot water before eating. The noodles are soaked to soften in hot water, and they can be eaten in a few minutes, where noodles for quick cooking are made of water, salt, appropriate formula and flour; and noodles for brewing are made of water, salt, appropriate starch and formula plus flour. Therefore, for attempts of making pasta into instant noodles that can be quickly cooked or brewed, such attempts are generally impossible due to the general structure and ingredients of pasta.

Instant noodles that are currently available for fast cooking or brewing are generally made through deep-frying, wherein water contained in the noodles are converted by oil temperature into vapor so as to generate voids through evaporation. However, such voids so formed will adsorb and hold oil therein (by approximately 22%-24%). The oil so adsorbed will be released during cooking or brewing to allow hot water to get into the noodles. This does not suit the modern people's idea concerning health care and may affect human health. Thus, to provide a physical fabrication process that produces, under a condition of being free of oil and additives, instant noodles that are no harm to human health is an issue for the manufacturers to improve in order to suit the modern people's need for health care.

In view of the above, the present invention aims to provide easy-to-cook and easy-to-brew noodles of a physical fabrication process, which combines an instant noodle fabrication process with characteristics of pasta to make paste fast cookable and brewable for eating.

### SUMMARY OF THE INVENTION

The primary objective of the present invention is to provide easy-to-cook and easy-to-brew noodles of a physical process, such that paste is made, through a fabrication process that is free of oil and additives, to be brewable or to be cooked in a short time, while not affecting consumers' heath.

The easy-to-cook and easy-to-brew noodles of a physical process provided above are generally such that an appropriate amount of strong/medium strength flour or semolina or durum wheat flour as a noodle base material; the noodle base material is mixed with appropriate amounts of water and salt and is subjected to molding through extrusion to form noodles of various shapes of thin strip, spiral, and sheet; the formed noodles are then steamed and fully cooked, and cut quantitatively, and are subjected to semi-puff drying or full-puff drying according to the thickness or set brewing time of the noodles, so as to make instant pasta through the physical fabrication process, allowing the pasta to be brewed or cooked in a short time, and fast edible.

In the above easy-to-cook and easy-to-brew noodles of the physical fabrication process, the strong/medium strength flour or semolina or durum wheat flour is about 77% by weight; the water is about 21% to 22% by weight; and the salt is about 1% to 2% by weight.

In the above easy-to-cook and easy-to-brew noodles of the physical fabrication process, in steaming, the noodles are steamed to become 100% fully cooked.

In the above easy-to-cook and easy-to-brew noodles of the physical fabrication process, the semi-puff drying is such that the noodles are placed on a net-like belt conveyor in an enclosed space and hot air flow of a temperature of about 120° C. to 150° C. blows toward the noodles for about 4 minutes, in which in the first 2 minutes, the hot air flow blows toward the noodles in a direction from an upper side toward a lower side, while in the last 2 minutes, the hot air flow blows toward the noodles in a direction from the lower side toward the upper side, so that uniform semi-puff drying of the noodles is achieved.

In the above easy-to-cook and easy-to-brew noodles of the physical fabrication process, the full-puff drying is such that the noodles are placed on a net-like belt conveyor in an enclosed space and hot air flow of a temperature of about 120° C. to 150° C. blows toward the noodles for about 4 minutes, in which in the first 2 minutes, the hot air flow blows toward the noodles in a direction from an upper side toward a lower side, while in the last 2 minutes, the hot air flow blows toward the noodles in a direction from the lower side toward the upper side, so that uniform full-puff drying of the noodles is achieved.

### BRIEF DESCRIPTION OF THE DRAWINGS

FIG. 1 is a flow chart of production of a preferred embodiment of the present invention.

FIG. 2 is a detailed flow chart of Step S12 of the present invention.

FIG. 3 shows a noodle before semi-puff drying according to the present invention.

FIG. 4 shows the noodle after semi-puff drying according to the present invention.

FIG. 5 is a flow chart of production of another preferred embodiment of the present invention.

FIG. 6 is a detailed flow chart of Step S22 of the present invention.

FIG. 7 shows a noodle before full-puff drying according to the present invention.

FIG. 8 shows the noodle after full-puff drying according to the present invention.

### DETAILED DESCRIPTION OF THE PREFERRED EMBODIMENT

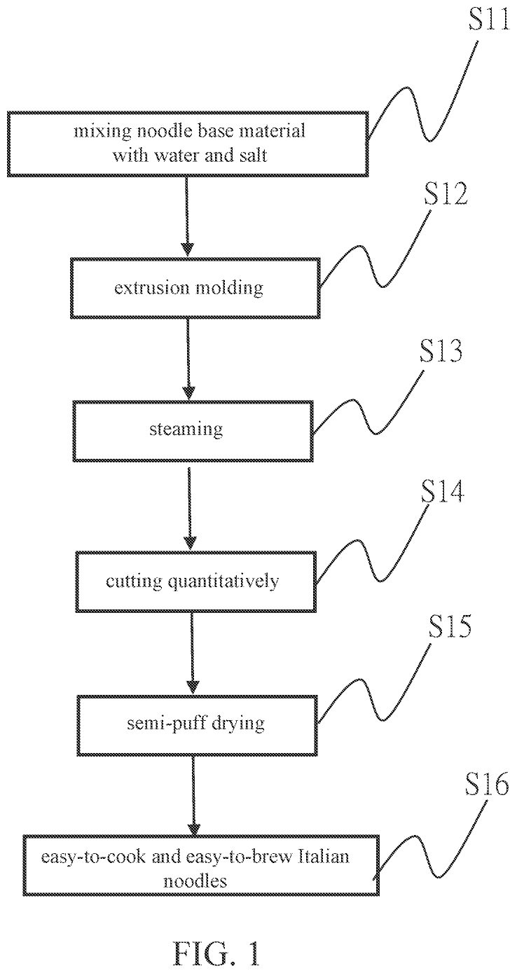

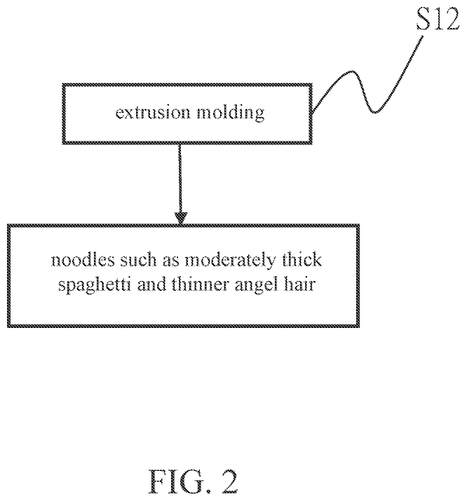

Referring simultaneously to FIGS. 1 and 2, a flow chart of production according to a preferred embodiment of the present invention is shown, and as shown in the drawings, the flow chart of production according to the present invention includes the following steps:

(1) mixing noodle base material with water and salt, S11, in which about 77% strong/medium strength flour or semolina or durum wheat flour is mixed with about 21%-22% water and about 1%-2% salt; in the embodiment, approximately 100 kilograms of strong/medium strength flour or semolina or durum wheat flour and approximately 30 kilograms of water and salt are used, an no oil or additives, such as leavening agent or starch;

(2) extrusion molding, S12, in which a mixture of the above strong/medium strength flour or semolina or durum wheat flour, water and salt into noodles is subjected to extrusion molding to form noodles; in the embodiment, the mixture is molded to form long strips of moderately thick spaghetti, thinner angel hair and other noodles by means of extrusion molding with different molds;

(3) steaming, S13, in which the formed noodles are steamed to be 100% fully cooked;

(4) cutting quantitatively, S14, in which the steamed noodles are cut quantitatively;

(5) semi-puff drying, S15, in which the steamed and quantitatively cut noodles are subjected to semi-puff drying; in the embodiment, the noodles are placed on a net-like belt conveyor in an enclosed space and hot air flow of a temperature of about 120-150° C. is blown at a flowing speed of 10 m/s toward the noodles for about 4 minutes, in which in the first 2 minutes, the hot air flow is blown toward the noodles in a direction from an upper side toward a lower side, while in the last 2 minutes, the hot air flow is blown toward the noodles in a direction from the lower side toward the upper side, so that uniform drying can be achieved by means of such an enclosed arrangement, and an effect of uniform semi-puff drying of the noodles is achieved; and

(6) making pasta that is easy to cook and brew, S16.

In the drying step of the above production process, the drying way is decided according to the thickness of the noodles and the setting of the brewing time, so that semi-puff drying is chosen in making noodles such as moderately thick spaghetti and thin angel hair, and during the course of semi-puff drying, due to the temperature of the hot air flow is set in the range between 120° C. and 150° C., evaporation of water vapor from the noodles in such a temperature range is not excessively violent, and thus, the noodles may maintain in their original shape, and the capillary pores generated therein are relatively small. In case that the temperature is made lower than 120° C., the noodles can only be dried slowly, and the vapor cannot erupt out of the noodles to form the capillary pores.

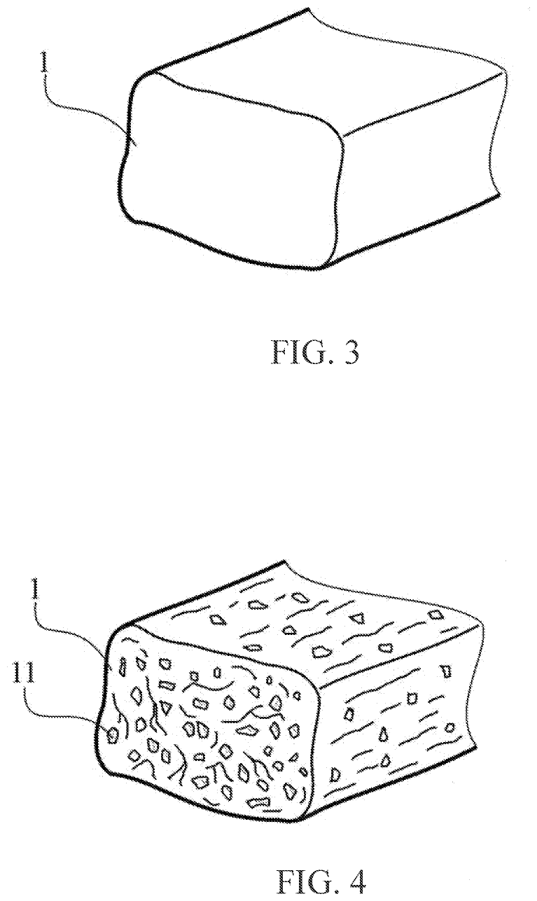

Referring simultaneously to FIGS. 3 and 4, which respectively show states of the present invention before and after semi-puff drying, as shown in FIG. 3, before semi-puff drying of a noodle 1 according to the present invention, the noodle 1 is in a smooth state and does not have wrinkles or pores, and as shown in FIG. 4, after semi-puff drying of the noodle 1 according to the present invention, the noodle 1 still maintain in its original shape, but in the longitudinal section, the noodle 1 forms a plurality of irregularly arranged small capillary pores 11. Since the diameters of the small capillary pores 11 are relatively small, during cooking, water can only enter relatively slowly, and the noodles are not cooked to become excessively soft, making this suitable for the taste of relatively hard as what pasta tastes.

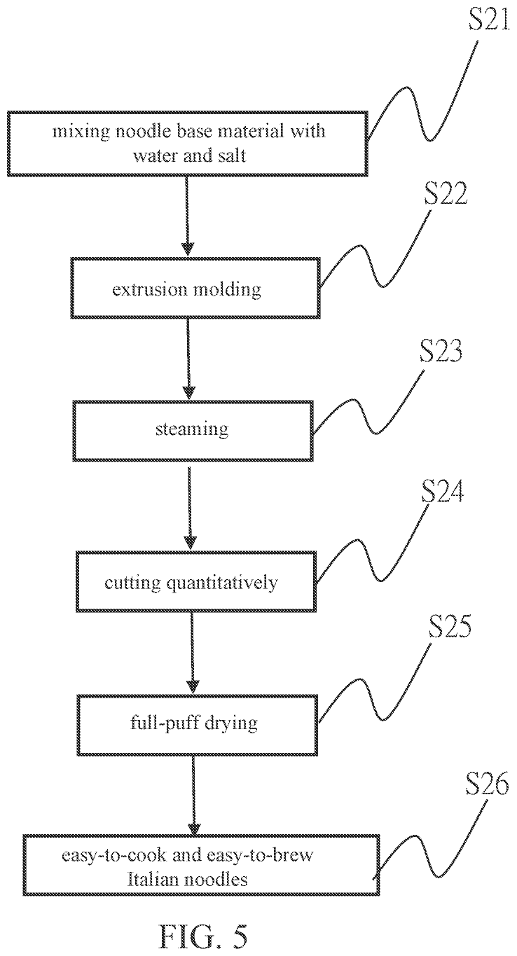

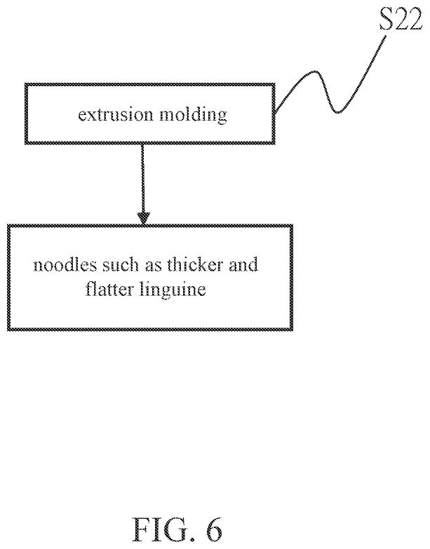

Referring simultaneously to FIGS. 5 and 6, a flow chart of production according to another preferred embodiment of the present invention is shown, and as shown in the drawings, another flow chart of production according to the present invention includes the following steps:

(1) mixing noodle base material with water and salt, S21, in which about 77% strong/medium strength flour or semolina or durum wheat flour is mixed with about 21%-22% water and about 1%-2% salt; in the embodiment, approximately 100 kilograms of strong/medium strength flour or semolina or durum wheat flour and approximately 30 kilograms of water and salt are used, an no oil or additives, such as leavening agent or starch;

(2) extrusion molding, S22, in which a mixture of the above semolina or durum wheat flour, water and salt is subjected to extrusion molding to form noodles; in the embodiment, the mixture is molded to form thick and flat noodles such as linguine by means of extrusion molding with different molds;

(3) steaming, S23, in which the formed noodles are steamed to be 100% fully cooked;

(4) cutting quantitatively, S24, in which the steamed noodles are cut quantitatively;

(5) full-puff drying, S25, in which the steamed and quantitatively cut noodles are subjected to full-puff drying; in the embodiment, the noodles are placed on a net-like belt conveyor in an enclosed space and hot air flow of a temperature of about 120-150° C. is blown at a flowing speed of 10 m/s toward the noodles for about 4 minutes, in which in the first 2 minutes, the hot air flow is blown toward the noodles in a direction from an upper side toward a lower side, while in the last 2 minutes, the hot air flow is blown toward the noodles in a direction from the lower side toward the upper side, so that uniform drying can be achieved by means of such an enclosed arrangement, and an effect of uniform full-puff drying of the noodles is achieved; and

(6) making pasta that is easy to cook and brew, S26.

In the drying step of the above production process, the drying way is decided according to the thickness of the noodle and the setting of the brewing time, so that full-puff drying is chosen in making noodles such as thick and flat linguine, and during the course of full-puff drying, due to the temperature is set in the range between 120° C. and 150° C., evaporation of water vapor from the noodles in such a temperature range is relatively violent, and the noodles may maintain their original shape and the capillary pores generated therein are relatively large, allowing water to enter relatively easily, water adsorption being relatively better, and the noodles do not become soft on the outside and hard in the inside due to insufficient cooking time, or do not become excessively soft on the outside while inside being cooked due to too long cooking time.

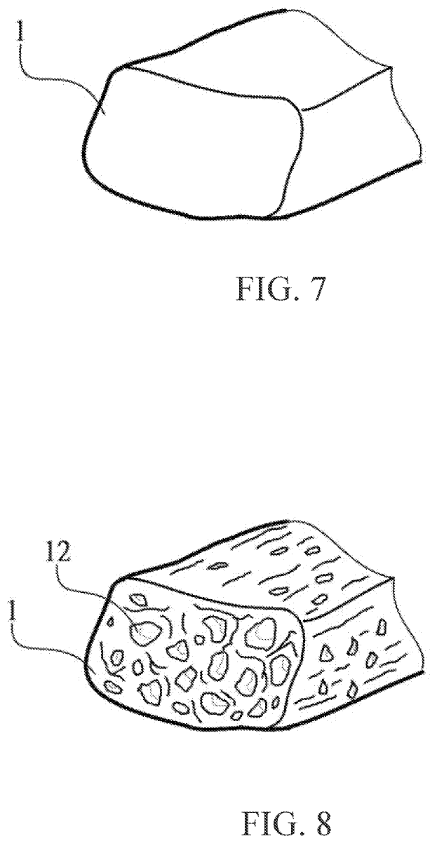

Referring simultaneously to FIGS. 7 and 8, which respectively show states of the present invention before and after full-puff drying, as shown in FIG. 7, before full-puff drying of a noodle 1 according to the present invention, the noodle 1 is in a smooth state and does not have wrinkles and pores, and as shown in FIG. 8, after full-puff drying of the noodle 1 according to the present invention, the noodle 1 puffs and becomes large, and in the longitudinal section, the noodle 1 forms a plurality of irregularly arranged large capillary pores 1. Since the diameters of the large capillary pores 12 are relatively large, water can enter relatively easily and water adsorption is relatively better, and the noodle can be served through brewing in a short period of time and does not get soft on the outside and hard in the inside due to insufficient cooking time, or does not get excessively soft on the outside while inside cooked due to too long cooking time.

The embodiments provided above are only some of the preferred ways of embodying the present invention, and are not provided for limiting the scope of the present invention. Minor modifications and alterations without departing from the gist of the present invention are considered within the scope of the present invention.

In summary, the present invention mixes semolina or durum wheat flour with water and salt, without adding any oil or additives, such as leavening agent or starch, and then forms the mixture into noodles by means of extrusion molding. Thereafter, according to the thickness of the noodles or the set brewing time thereof, the noodles are subjected to semi-puff drying or full-puff drying, so as to integrate the production process of instant noodles with the characteristics of pasta to make instant pasta, so that the pasta becomes brewable or can be cooked in a short time, and does not affect human body health due to no addition of oil or additives, such as leavening agent or starch.

I claim:

1. Easy-to-cook and easy-to-brew noodles of physical fabrication process, comprising the following steps:
providing an appropriate amount of strong/medium strength flour or semolina or durum wheat flour as a noodle base material;
mixing the noodle base material with water and salt;
subjecting a mixture of the noodle base material, water and salt to extrusion molding to form moderately thick or thinner noodles;
steaming the formed noodles to be fully cooked;
cutting the steamed noodle quantitatively; and
placing the steamed and quantitatively cut noodles on a net-like belt conveyor in an enclosed space and blowing hot air flow of a temperature of about 120-150° C. at a flowing speed of 10 m/s toward the noodles for about 4 minutes, in which in first 2 minutes, the hot air flow is blown toward the noodles in a direction from an upper side toward a lower side, while in last 2 minutes, the hot air flow is blown toward the noodles in a direction from the lower side toward the upper side, so that uniform drying is achieved by means of such an enclosed arrangement, and an effect of uniform semi-puff drying of the noodles is achieved to make easy-to-cook and easy-to-brew pasta.

2. The easy-to-cook and easy-to-brew noodles of physical fabrication process according to claim 1, wherein, in the step of mixing, semolina or durum wheat flour is about 77% by weight, the water is about 21% to 22% by weight, and the salt is about 1% to 2% by weight.

3. The easy-to-cook and easy-to-brew noodles of physical fabrication process according to claim 1, wherein, in the step of steaming, the formed noodles are steamed to become 100% fully cooked.

4. Easy-to-cook and easy-to-brew noodles of physical fabrication process, comprising the following steps:
providing an appropriate amount of strong/medium strength flour or semolina or durum wheat flour as a noodle base material;
mixing the noodle base material with water and salt;
subjecting a mixture of the noodle base material, water and salt to extrusion molding to form thicker and flatter noodles;
steaming the formed noodles to be fully cooked;
cutting the steamed noodle quantitatively; and
placing the steamed and quantitatively cut noodles on a net-like belt conveyor in an enclosed space and blowing hot air flow of a temperature of about 120-150° C. at a flowing speed of 10 m/s toward the noodles for about 4 minutes, in which in first 2 minutes, the hot air flow is blown toward the noodles in a direction from an upper side toward a lower side, while in last 2 minutes, the hot air flow is blown toward the noodles in a direction from the lower side toward the upper side, so that uniform drying is achieved by means of such an enclosed arrangement, and an effect of uniform full-puff drying of the noodles is achieved to make easy-to-cook and easy-to-brew pasta.

5. The easy-to-cook and easy-to-brew noodles of physical fabrication process according to claim 4, wherein, in the step of mixing, semolina or durum wheat flour is about 77% by weight, the water is about 21% to 22% by weight, and the salt is about 1% to 2% by weight.

6. The easy-to-cook and easy-to-brew noodles of physical fabrication process according to claim 4, wherein, in the step of steaming, the formed noodles are steamed to become 100% fully cooked.
